(19) United States
(12) Patent Application Publication
(10) Pub. No.: US 2015/0332839 A1
(43) Pub. Date: Nov. 19, 2015

(54) INDUCTIVE CHARGING COIL DEVICE

(71) Applicant: ROBERT BOSCH GMBH, Stuttgart (DE)

(72) Inventors: Friederike Stock, Stuttgart (DE); Guenter Lohr, Leinfelden-Echterdingen (DE); Wilifried Aichele, Winnenden (DE); Dragan Krupezevic, Stuttgart (DE); Juergen Mack, Goeppingen (DE); Marcin Rejman, Waiblingen (DE)

(21) Appl. No.: 14/653,356

(22) PCT Filed: Dec. 18, 2012
(86) PCT No.: PCT/EP2013/077155

§ 371 Date: Jun. 18, 2015

(30) Foreign Application Priority Data
Dec. 21, 2012 (DE) 10 2012 112 876.6
Dec. 21, 2012 (DE) 10 2012 112 878.2
Dec. 21, 2012 (DE) 10 2012 112 883.9
Dec. 21, 2012 (DE) 10 2012 112 992.4
Dec. 21, 2012 (DE) 20 2012 105 016.1
Dec. 17, 2013 (DE) 10 2013 226 224.8

(51) Int. Cl. H01F 27/28; H01F 41/02; H01F 27/255; H02J 7/02

(52) U.S. Cl. CPC H01F 27/2804; H02J 7/025; H01F 41/02; H01F 27/255

(57) ABSTRACT

An inductive charging coil device, in particular a hand-held power tool inductive charging coil device, includes at least one coil unit and at least one core unit. It is provided that the core unit is at least partially formed by microscopic core elements embedded in a binder.

### FIELD OF THE INVENTION

The present invention is directed to an inductive charge coil device, in particular a hand-held power tool inductive charging coil device, including at least one coil unit and at least one core unit.

### BACKGROUND INFORMATION

Inductive charging coil devices, in particular hand-held power tool inductive charging coil devices, including at least one coil unit and at least one core unit are known.

### SUMMARY OF THE INVENTION

The present invention is directed to an inductive charge coil device, in particular a hand-held power tool inductive charging coil device, including at least one coil unit and at least one core unit.

It is provided that the core unit be at least partially formed by microscopic core elements embedded in a binder. A “coil unit” is to be understood in this context in particular as a unit which has at least one conductor loop including at least one winding formed by a conductor. The coil unit is provided to transmit and/or to receive electrical energy in at least one operating state. The coil unit may have a winding support. The winding support may be provided in particular to support the at least one conductor loop. The coil unit may be provided to supply received energy, in particular via a voltage transformer and/or charging electronics, to a consumer and/or a cell unit of a rechargeable battery. Alternatively, the hand-held power tool inductive charging coil device may be provided to transmit energy to a further inductive charging coil device. The coil unit may be provided to convert an electric alternating current into a magnetic alternating field and/or vice versa. In particular, the inductive charging coil device may form an inductive energy transmission system with a further inductive charging coil device. The alternating field may have a frequency of 10 kHz-500 kHz, particularly 100 kHz-120 kHz. A “hand-held power tool inductive charging coil device” is to be understood in this context in particular as an inductive coil charging device of a hand-held power tool, a hand-held power tool rechargeable battery, or a hand-held power tool rechargeable battery charging device. A “hand-held power tool” is to be understood in this context as an electrical device which is hand-operated by a user, such as, in particular, a power drill, a drill hammer, a saw, a plane, a screwdriver, a milling tool, a grinder, an angle grinder, and/or a multifunction tool, or a garden tool such as a hedge trimmer, and shrub and/or grass shears.

A “core unit” is to be understood in this context in particular as a device which is provided to focus an electromagnetic alternating field. In particular, the core unit may be formed at least partially by a magnetic material. A “magnetic material” may be to be understood in this context as a ferromagnetic, in particular magnetically soft, material. Alternatively, it is also conceivable to use ferromagnetic and/or antiferromagnetic materials. A “core element” is to be understood in this context in particular as integral parts of the core unit which are at least essentially responsible for the magnetic properties of the core unit. The core elements may be at least predominantly formed by the magnetic material. “Microscopic” is to be understood in this context in particular as a core element, the largest extension of which is less than 1 mm, which may be less than 0.1 mm, particularly less than 0.01 mm. In particular, the microscopic core elements may be formed as a powder of a magnetic material. A “binder” is to be understood in this context in particular as a binder which is provided to form what may be an integrally joined bond with the core elements. Binder and core elements may form a composite material. The binder may be formed by a plastic material, such as, in particular, a thermoplastic or synthetic resin. The core elements may be admixed to the binder, so that the core unit may be produced by a casting process and/or an injection molding process. Alternatively, the core elements may be molded using the binder. The core elements may be potted using the binder and/or the core elements may be at least partially coated using the binder. The core unit may have a trough, in which the core elements are potted using the binder. Alternatively, the core unit may be demolded from the trough after the potting, so that the trough may be used for casting multiple core units. The core elements may be potted in a binder implemented as a casting resin, in particular an epoxy resin.

Alternatively, the binder may contain linearly polymerizing monomer building blocks and/or oligomer building blocks of a thermoplastic such as lactams and/or cyclic oligomers of butylene terephthalate. The binder may enclose the core elements and polymerize to form a polymer, such as, in particular, a polyamide. This operation may take place more rapidly than curing of an epoxy resin. Manufacturing and/or curing of the core unit may take place in a particularly short time span. Manufacturing of the core unit may be particularly simple. In particular, the core unit may be manufactured in a desired shape by a casting and/or injection molding process. The core unit may be formed by original molds. Post-processing of the core unit may be omitted or may be particularly simple. The binder may be particularly fracture-resistant. The core unit may be particularly tough and fracture-resistant. The core unit may be particularly durable in relation to mechanical stresses, in particular in comparison to a core unit formed by a sintering material in a sintering process. Shattering of the core unit may be made more difficult. A service life and/or a level of robustness of the core unit may be particularly long or high, respectively.

Alternatively, it is provided that the core unit has a plurality of core elements, which are at least partially formed by sintered pieces. A “sintered piece” is to be understood in this context in particular as a fragment and/or granule of a sintered material, in particular a sintered ferrite material. The sintered pieces may be at least 70%, advantageously at least 80%, particularly advantageously at least 90% formed by a manganese-zinc (MnZn) and/or nickel-zinc (NiZn) sintered material. The sintered pieces may particularly advantageously have magnetic properties. The sintered pieces may have an irregular fragment shape. The core unit may at least essentially have the advantageous properties of a core unit formed by a sintered ferrite material. In particular, magnetic losses may be low. The core unit may have a high permeability. A relative permeability μ of the core unit may be, at least in partial areas of the core unit, greater than 100, which may be greater than 1000, particularly greater than 5000.

The core unit may be particularly cost-effective. In particular, the core unit may be more cost-effective than a core unit which is formed by one sintered piece and/or a small number of sintered pieces. A “small” number is to be understood in this context as a number less than 50, which may be less than 25, particularly less than 10. The core elements may be potted using the binder. The binder may form a particularly fracture-resistant unit with the core elements, in particular a fracture resistance may be higher than in the case of a core unit which is formed by one sintered component. Alternatively, the core elements may be lacquered over, i.e., coated, using a binder implemented as a lacquer. The core elements may stick to one another. Particularly little binder may be required. Cavities between the core elements may remain at least partially free. The core unit may have a particularly low mass. The binder may contain additional microscopic core elements. The magnetic properties of the core unit may be improved further. Large-area and/or large-volume core units may be formed particularly easily. Shrinking of sintered components may be neglected. A setpoint geometry of the core unit may be ensured particularly easily. The sintered pieces may particularly be formed by fragments of recycled sintered components, in particular core units.

Damaged and/or obsolete core units may advantageously be reused and form core elements of the core unit according to the present invention. Resources may be saved. The sintered pieces may be cost-effective. The core elements may have a mean diameter which corresponds to at most ⅔ of a core height. A “core height” is to be understood in this context in particular as a height of the core unit in the direction of the winding axis of the coil unit. In the case of a core unit having areas of differing height, the “core height” may be to be understood as the smallest height of the core unit. It may be effectively ensured that the core elements are situated inside the core height during the manufacturing of the core unit. Core elements may be prevented from protruding out of the core.

Furthermore, it is provided that the core unit has a core jacket, which is provided for fixing the core elements. A “core jacket” is to be understood in this context in particular as an envelope which envelops the core elements. In particular, the core jacket may be formed by a film and/or a thin-walled elastomeric and/or thermoplastic material. The core unit may be formed by deep drawing a thermoplastic film on one or both sides, the thermoplastic film enclosing the core elements. Alternatively, the core elements may be shrink-wrapped in a core jacket formed by shrinkable tubing. In another embodiment of the present invention, the core elements may be enveloped by film tubing, which is sealed by a hot sealing method. A binder may be omitted. Furthermore, the core elements may be fixed in a core jacket by vacuum packing the core jacket. Furthermore, a stabilizing arrangement may be situated inside the core jacket, which holds the core jacket and the core elements essentially in setpoint geometry. The core elements have rounded edges in particular. Alternatively, the core jacket could be implemented as sufficiently stable. The core elements of the core unit may be held by the core jacket in a setpoint geometry and/or a desired spatial arrangement. The core elements may have an at least restricted mobility inside the core jacket. The core unit may be flexible and/or moldable. A shape of a core unit formed by core elements enveloped in a core jacket may be adapted during assembly of the inductive charging coil device.

Furthermore, it is provided that the core unit has areas having a differing core material composition. A “core material composition” is to be understood in this context in particular as a chemical and/or physical composition of core materials forming an area of the core unit, such as, in particular, a composition of magnetic materials and binders forming the area of the core unit. An “area” is to be understood in this context in particular as an integrally joined, coherent area of the core unit, in particular a layer of the core unit. A volume of an area is advantageously at least 5%, which may be at least 10%, particularly at least 15% of a total volume of the core unit. The core material composition may be adapted particularly well to various requirements within the core unit. In particular, the core material composition, in areas which have a high field strength during operation of the coil unit, may be particularly well suitable for focussing a magnetic field. The core material composition in areas having a high mechanical stress, such as in the area of a bearing arrangement, which is provided for supporting the core unit, may be particularly fracture-resistant. The core unit may be particularly cost-effective in areas without special requirements. Those skilled in the art may select the core material composition optimally in particular with regard to functional costs and material costs. The core unit may be particularly efficient and/or durable and/or cost-effective.

Furthermore, it is provided that the core unit has at least two core materials, which have differing permeabilities. The core unit may have different types of magnetic materials and/or core elements, which are each made of a material or a material mixture having a differing permeability. Core elements and binders may have different permeabilities. The magnetic properties of the core unit may be adapted particularly well.

In one particularly advantageous embodiment of the present invention, it is provided that the core unit has at least two core materials, which have differing densities and/or moduli of elasticity. In particular, the densities and/or the moduli of elasticity of magnetic materials and/or core elements and/or binders may differ. Areas of the core unit which are particularly at risk of fracture may be formed at least predominantly by a particularly elastic core material. Less stressed areas of the core unit and/or areas of the core unit which have a low magnetic field strength during operation may be formed by a core material having a particularly low density. The core unit may be particularly fracture-resistant. The core unit may have a particularly low mass. Furthermore, it is provided that at least one area of the core unit is at least essentially formed by air. In particular, the core unit may have at least one air layer and/or at least one air entrapment. In particular, areas of the core unit which have a low magnetic field strength during operation may have air entrapments and/or air layers. The core unit may have a particularly low mass. The core unit may be particularly cost-effective. Particularly little core material may be necessary for manufacturing the core unit.

Furthermore, it is provided that at least two areas having a differing core material composition in a thickness direction of the core unit form layers situated adjacent to one another. A “thickness direction” of the core unit is to be understood in this context in particular as the direction of the core unit, in which the core unit has the smallest extension. The thickness direction is advantageously at least essentially the direction of a winding axis of the coil unit. A “winding axis” is to be understood in this context in particular as an axis which extends in the middle through a center of the windings of the conductor loops of the at least one coil unit of the inductive charging coil device. “At least essentially” is to be understood in this context in particular to mean a deviation of less than 10°, which may be less than 5°. A “layer” is to be understood in this context in particular as a coherent planar area, which extends perpendicularly to the thickness direction over more than 80%, which may be more than 90% of the core unit.

The layers of the core unit facing toward the coil unit may advantageously have a core material composition having a particularly high permeability and/or having a particularly large proportion of magnetic materials. Layers of the core unit facing away from the coil unit may advantageously have a particularly fracture-resistant and/or light and/or cost-effective core material composition. The core unit may have particularly advantageous magnetic and/or mechanical properties. Furthermore, it is provided that at least two areas having a differing core material composition are integrally joined to one another. One area may advantageously be implemented as a coating of another area. In particular, a layer of a core material having a particularly high permeability may be applied in a coating method to a layer of a core material having a lower permeability, which is used as a carrier layer. The coating may be supported particularly well by the carrier layer. The core unit may be particularly robust.

Furthermore, it is provided that at least two areas having a differing core material composition are situated radially around the winding axis of the coil unit. The areas may advantageously be situated at least essentially in the shape of a cylinder and/or hollow cylinder around the winding axis. “At least essentially” is to be understood in this context as a deviation of a volume distribution of less than 20%, which may be less than 10%, from a cylinder and/or hollow cylinder shape around the winding axis. Advantageously, areas which are situated in the direction of the winding axis adjacent to the windings of the coil unit and/or areas which have a particularly small distance to the windings may have a core material composition having a particularly high permeability and/or having a particularly large proportion of magnetic materials. Areas which are situated in a radius around the windings inside or outside the windings may advantageously have a particularly fracture-resistant and/or light and/or cost-effective core material composition. The core unit may have particularly advantageous magnetic and/or mechanical properties. In one particularly advantageous embodiment of the present invention, it is possible that areas are situated radially and in layers, a permeability of the areas advantageously decreasing with increasing distance from the windings of the coil unit. Areas are also conceivable, whose core material composition and/or permeability changes continuously, in particular, their permeability decreases continuously with increasing distance from the windings. The magnetic properties of the core unit may be particularly advantageous.

Furthermore, it is provided that the core unit at least essentially has a plate-shaped or trough-shaped configuration. The core unit may have an extension which corresponds to at least a diameter of the conductor loops of the coil unit around a winding axis. A “winding axis” is to be understood in this context in particular as an axis which extends in the middle through a center of the windings of the conductor loops of the at least one coil unit of the inductive charging coil device. The core unit may cover the coil unit at least essentially without recesses. The core unit may focus a magnetic alternating field particularly effectively in the area of the coil unit.

Furthermore, it is provided that the core elements have a mean diameter which corresponds to at most ⅔ of a core height. A “core height” is to be understood in this context in particular as a height of the core unit in the direction of the winding axis of the coil unit. In a core unit having areas having differing heights, the “core height” may be understood as the smallest height of the core unit. It may be effectively ensured that the core elements are situated within the core height during the manufacturing of the core unit. Core elements may be prevented from protruding out of the core.

Furthermore, it is provided that the inductive charging coil device has a housing unit, into which the core unit is cast and/or injection molded. A “housing unit” is to be understood in this context in particular as a housing, which at least essentially encloses at least the coil unit and the core unit. The housing unit may be an integral part of a hand-held power tool rechargeable battery charging device. The housing unit may be an integral part of a hand-held power tool rechargeable battery pack and/or a hand-held power tool. “Cast” is to be understood in this context in particular as integrally joined and/or embedded by enveloping using a casting compound. “Injection molded” is to be understood in this context in particular as a method in which a core material forming the core unit after solidification or a core material mixture forming the core unit is molded on the housing unit and/or injected into the housing unit in a liquid and/or plastic state in a casting method, in particular an injection molding method.

The core unit may be particularly effectively connected to the housing unit. The housing unit may protect the core unit particularly well, in particular from mechanical influences. Breaking of the core unit may be prevented. The core unit may be supported particularly securely on the housing unit. Further components for supporting the core unit on the housing unit may be omitted. The inductive charging coil device may be particularly robust and/or cost-effective. An electronics unit may be at least partially cast jointly with the core unit and/or at least partially embedded in the core unit. The electronics unit is advantageously cast into the core unit and/or embedded in the core unit by more than 50%, which may be by more than 80%, particularly completely. An “electronics unit” is to be understood in this context in particular as a device which has at least one electrical and/or electronic component. The electronics unit may advantageously have charging electronics of the hand-held power tool rechargeable battery pack and/or the hand-held power tool rechargeable battery charging device. The electronics unit and the core unit may be moved into the receptacle area and cast jointly. The electronics unit and the core unit may particularly be connected permanently to the housing unit. The electronics unit and the core unit may be protected particularly well from environmental influences, in particular from moisture and/or contaminants. In one alternative embodiment of the present invention, the electronics unit may be embedded in the core unit. “Embedded” is to be understood in this context in particular to mean that the core unit entirely or partially encloses the electronics unit.

In particular, the electronics unit may be extrusion coated and/or embedded using the core material forming the core unit and/or the core material mixture forming the core unit. After solidification, the core unit may form a unit with the electronics unit. The core unit may protect the electronics unit particularly well. Core unit and electronics unit may be situated particularly compactly in the housing unit. Furthermore, it is provided that the coil unit is cast at least partially jointly with the core unit and/or is embedded at least partially in the core unit. The coil unit is advantageously cast into the core unit and/or embedded in the core unit by more than 50%, which may be by more than 80%, particularly completely. In particular, the coil unit may be cast with the core unit and/or embedded in the core unit jointly with the electronics unit. The inductive charging coil device including the core unit, the coil unit, and the electronics unit may form a particularly robust unit with the housing unit. The inductive charging coil device may be protected particularly well from soiling and/or moisture and/or vibrations. The inductive charging coil device may be particularly long-lasting.

Furthermore, it is provided that the housing unit has a pocket-like receptacle area for the coil unit and/or the core unit and/or an electronics unit, whereby a particularly simple assembly of the coil device may be achieved. The coil unit and the core unit may advantageously be supported by the housing unit. A “pocket-like receptacle area” is to be understood in particular as a receptacle area which forms a pocket in or on the housing. A “pocket” is to be understood in this context in particular as a subspace of the housing unit, which is implemented as at least essentially closed in particular at least in an operational state. “At least essentially” is to be understood in this context in particular to mean that more than 80%, which may be more than 90%, particularly more than 95% of an overall surface of the receptacle area is implemented as closed. The receptacle area advantageously has assembly openings, which may be closed by covers in an operational and/or assembled state.

In particular, the receptacle area may be delimited by an inner wall of the housing unit in the direction of a cell unit. A “cell unit” is to be understood in this context in particular as an energy storage unit, which has at least one rechargeable battery cell, which is provided in particular for electrochemical storage of electrical energy. The rechargeable battery cell may be a lead rechargeable battery cell, a NiCd rechargeable battery cell, a NiMh rechargeable battery cell, but in particular a lithium-based rechargeable battery cell. Further types of rechargeable battery cells known to those skilled in the art are also conceivable. The coil device may be protected particularly well. In particular, the coil unit and/or the core unit and/or the electronics unit and the cell unit may be spatially separated. A heat transfer and/or a propagation of an electromagnetic alternating field from the area of the coil unit and/or the core unit and/or the electronics unit into adjoining areas, in particular in the direction of the cell unit, may be reduced. The receptacle area may accommodate the coil unit and the core unit. An assembly may have the coil unit and the core unit. An assembly of the coil device may be particularly simple. The coil unit and the core unit may be supported particularly securely by the housing unit.

It is provided that the receptacle area is provided to accommodate the coil unit and/or the core unit and/or the electronics unit in an insertion direction at least essentially in parallel to a main surface extension of the core unit and/or the electronics unit. “At least essentially” is to be understood in this context in particular to mean a deviation of less than 10°, which may be less than 5°. The core unit and/or the electronics unit may be assembled particularly easily. The receptacle area may have at least one bearing unit, which is provided for supporting the coil unit and/or the core unit and/or the electronics unit. The bearing unit may leave a translation of the coil unit and/or the core unit and/or the electronics unit free in the insertion direction. In particular, the bearing unit may be formed by at least one guide rail. The coil unit and/or the core unit and/or the electronics unit may advantageously be introduced into the receptacle area by insertion and supported by the bearing unit. The housing unit may have an assembly opening, through which the coil unit and/or the core unit and/or the electronics unit may be inserted in the insertion direction into the receptacle area. The assembly opening may be closed by a cover element. Assembly of the coil unit and/or the core unit and/or the electronics unit may be particularly simple. Assembly material and/or fastening material may be omitted.

Furthermore, it is provided that main surfaces of the receptacle area are at least essentially closed. In particular, the main surfaces may be at least essentially closed in an assembled, operational state of the coil device. “At least essentially” is to be understood in this context in particular to mean that the main surfaces are closed by more than 75%, which may be by more than 90%, particularly by more than 95%. The main surfaces may be closed by partition walls, which are part of the housing unit. An electrical insulation and/or a mechanical protection of the coil unit and/or the core unit and/or the electronics unit may be improved. Recesses of the receptacle area may be provided to receive connecting leads, to contact the coil unit with the cell unit. The cell unit may advantageously receive energy from the coil device.

Furthermore, a system having two inductive charging coil devices is provided, in which the core unit of at least one of the inductive charging coil devices has a plurality of core elements, which are formed at least partially by sintered pieces, whereby the core elements have a mean diameter which is at least 10 μm multiplied by a ratio of a core diameter of the core unit divided by an air gap in at least one operating state of the inductive charging coil devices. In particular, one inductive charging coil device may be part of a hand-held power tool rechargeable battery pack and one inductive charging coil device may be part of a hand-held power tool rechargeable battery charging device. An “air gap” is to be understood in this context as a distance of the two core units in an operational arrangement of the two inductive charging coil devices in relation to one another. In particular, the air gap exists between the two core units when the hand-held power tool rechargeable battery pack is placed on the hand-held power tool rechargeable battery charging device, to charge the hand-held power tool rechargeable battery pack. The size of the air gap is established by those skilled in the art during configuration of the hand-held power tool devices containing the inductive charging coil devices. The core elements may advantageously have magnetic properties. Particularly small core elements may be used. The core elements may be particularly cost-effective. The core elements may be situated particularly well in the core unit. The core elements may be situated particularly densely in the core unit. A minimum size of the core elements may be ensured. In particular, the magnetic properties may be worse in the case of smaller core elements.

Furthermore, a method is provided for manufacturing a core unit having the described features. In particular, the method may include a plurality of core elements, which are microscopic and/or formed by sintered fragments, being introduced with a binder into a container and being potted or coated using the binder, and the binder subsequently curing to form a core unit. The container may subsequently be removed or may remain part of the core unit. Alternatively, the method may include a plurality of core elements being enveloped by a packing material and, in a further step, a closed core jacket being formed by the packing material around the core elements, by sealing the packing material by hot sealing or a core unit being formed by the packing material and the core elements enclosed in the packing material in a deep drawing process. The core unit may be manufactured particularly cost-effectively. The core unit may be manufactured in a particularly large bandwidth of shapes and sizes. The core unit may be particularly robust and fracture-resistant.

Furthermore, a hand-held power tool device including a hand-held power tool inductive charging coil device having the described features is provided. In this case, the hand-held power tool device may be formed by a hand-held power tool, a hand-held power tool rechargeable battery pack, a hand-held power tool case, or a hand-held power tool rechargeable battery charging device. The hand-held power tool device may have the above-mentioned advantages of the hand-held power tool inductive charging coil device.

Further advantages result from the following description of the drawings. Exemplary embodiments of the present invention are shown in the drawings. The drawings, the description, and the claims contain numerous features in combination. Those skilled in the art will also advantageously consider the features individually and combine them to form further reasonable combinations.

### BRIEF DESCRIPTION OF THE DRAWINGS

FIG. 1 shows a schematic view of a core unit of an inductive charging coil device.

FIG. 2 shows a schematic view of a section through a hand-held power tool rechargeable battery pack including the inductive charging coil device.

FIG. 3 shows a schematic sectional view of a core unit of an inductive charging coil device in a second exemplary embodiment including a plurality of core elements formed by sintered fragments.

FIG. 4 shows a schematic sectional view through a hand-held power tool rechargeable battery pack including the inductive charging coil device of the second exemplary embodiment and a hand-held power tool rechargeable battery charging device including a further inductive charging coil device.

FIG. 5 shows a schematic sectional view of an arrangement of the core unit of the hand-held power tool rechargeable battery pack of the second exemplary embodiment and a core unit of the hand-held power tool rechargeable battery charging device in relation to one another in an operational state.

FIG. 6 shows a schematic sectional view of a manufacturing method of a core unit in a third exemplary embodiment.

FIG. 7 shows a schematic sectional view of the core unit of the third exemplary embodiment.

FIG. 8 shows a schematic sectional view of a hand-held power tool rechargeable battery pack including an inductive charging coil device in a fourth exemplary embodiment.

FIG. 9 shows a schematic sectional view of a coil unit and a core unit of an inductive charging coil device in a fifth exemplary embodiment.

FIG. 10 shows a schematic sectional view of a coil unit and a core unit of an inductive charging coil device in a sixth exemplary embodiment.

FIG. 11 shows a schematic sectional view of a hand-held power tool rechargeable battery pack including an inductive charging coil device and a hand-held power tool rechargeable battery charging device including a further inductive charging coil device in a seventh exemplary embodiment.

FIG. 12 shows a schematic view of a base part of the hand-held power tool rechargeable battery pack including the inductive charging coil device of the seventh exemplary embodiment.

FIG. 13 shows a schematic view of a housing unit of a hand-held power tool rechargeable battery pack including an inductive charging coil device in an eighth exemplary embodiment.

FIG. 14 shows a schematic sectional view of a core unit and a coil unit of an inductive charging coil device in a ninth exemplary embodiment.

FIG. 15 shows a schematic sectional view through a hand-held power tool rechargeable battery pack including the inductive charging coil device of the ninth exemplary embodiment and through a hand-held power tool rechargeable battery charging device including a further inductive charging coil device.

FIG. 16 shows a schematic sectional view of a hand-held power tool rechargeable battery including an inductive charging coil device in a tenth exemplary embodiment.

FIG. 17 shows a schematic sectional view through an electronics unit, a core unit, and a coil unit of the inductive charging coil device of the tenth exemplary embodiment.

FIG. 18 shows a schematic sectional view of the hand-held power tool rechargeable battery including the inductive charging coil device of the tenth exemplary embodiment and a hand-held power tool rechargeable battery charging device including a further inductive charging coil device.

FIG. 19 shows a schematic sectional view through an electronics unit, a core unit, and a coil unit of an inductive charging coil device in an eleventh exemplary embodiment.

### DETAILED DESCRIPTION

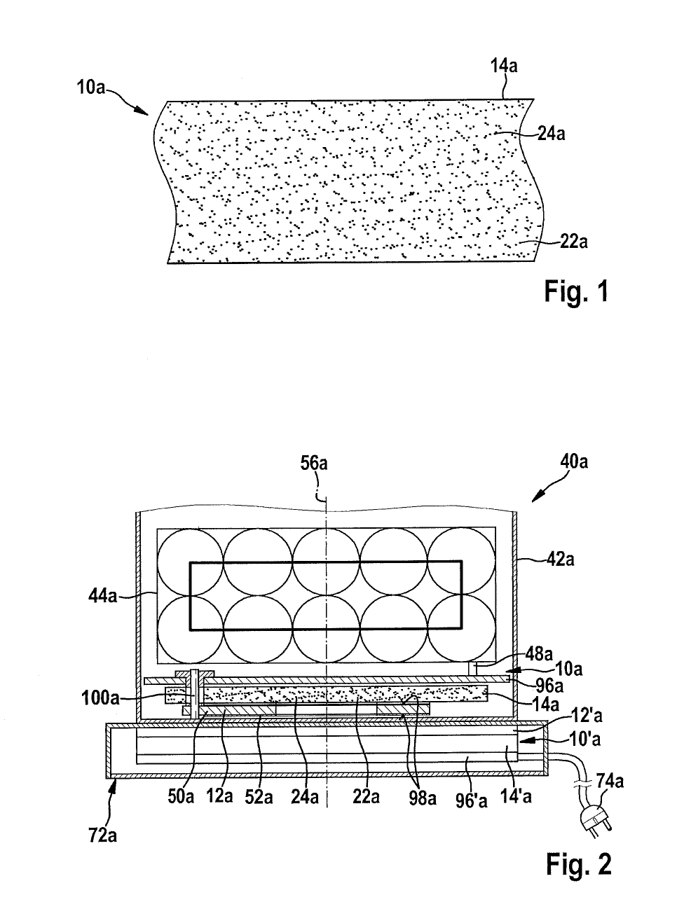

FIG. 1 shows a core unit 14a of a hand-held power tool inductive charging coil device 10a, which is formed by microscopic core elements 24a embedded in a binder 22a. Core unit 14a is provided for focussing a magnetic alternating field of a coil unit 12a (FIG. 2). Core elements 24a are formed by a ferrite material. Core unit 14a has a plate-shaped configuration. Core elements 24a are implemented as a ferrite powder, the ferrite powder having a grain size of less than 0.1 mm. Core elements 24a are admixed to binder 22a, which is formed by a casting resin. Core unit 14a is manufactured in a casting process by casting the mixture thus formed by binder 22a and core elements 24a.

FIG. 2 shows a section through a hand-held power tool rechargeable battery pack 40a including an inductive charging coil device 10a. A cell unit 44a is situated in a housing unit 42a. Cell unit 44a forms a hand-held power tool rechargeable battery, which is provided for an energy supply of a hand-held power tool. Inductive charging coil device 10a is situated in housing unit 42a on a side opposite cell unit 44a. Proceeding from cell unit 44a, inductive charging coil device 10a has a printed circuit board 96a including charging electronics for cell unit 44a. Plate-shaped core unit 14a is situated adjoining printed circuit board 96a. Coil unit 12a is situated adjoining core unit 14a. Coil unit 12a has a printed circuit board 52a including printed conductors situated on both sides of a carrier layer 50a. The printed conductors form two conductor loops having windings 98a around a winding axis 56a of coil unit 12a, which are situated on both sides of carrier layer 50a. Carrier layer 50a exercises the function of a winding support of windings 98a. Alternatively, windings may be made of at least one litz wire wound onto a winding support. A contacting unit 100a guided through core unit 14a connects printed circuit board 96a, which includes charging electronics, to coil unit 12a. Printed circuit board 96a including charging electronics is connected via a connecting lead 48a to cell unit 44a.

To charge cell unit 44a, hand-held power tool rechargeable battery pack 40a is placed on a hand-held power tool rechargeable battery charging device 72a, which includes a similarly constructed inductive charging coil device 10′a. Hand-held power tool rechargeable battery charging device 72a has a current supply 74a. If hand-held power tool rechargeable battery charging device 72a is supplied with current, a high-frequency alternating current of 100 kHz flows through inductive charging coil device 10′a, which is generated by charging electronics situated on a printed circuit board 96′a. A magnetic alternating field is generated in a coil unit 12′a, which is focussed by a core unit 14′a and emitted essentially in the direction of inductive charging coil device 10a. A current, using which cell unit 44a may be charged, is induced in coil unit 12a of inductive charging coil device 10a.

The following description and the drawing of eleven further exemplary embodiments are restricted essentially to the differences between the exemplary embodiments, reference fundamentally being able to be made to the drawing and/or the description of the other exemplary embodiments with respect to identically identified components, in particular in relation to components having identical reference numerals. To differentiate the exemplary embodiments, instead of the letter a of the first exemplary embodiment, the letters b through k are added to the reference numerals of the further exemplary embodiments.

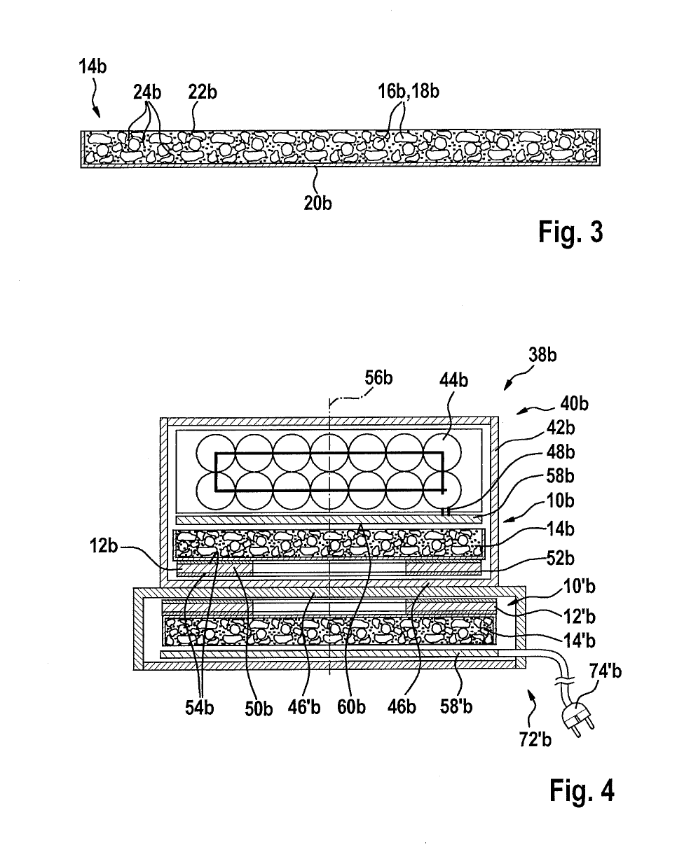

FIG. 3 shows a core unit 14b of an inductive charging coil device 10b (FIG. 4) in a second exemplary embodiment. Core unit 14b has a plurality of core elements 16b, which are formed by sintered fragments 18b. Furthermore, core unit 14b has a binder 22b and a trough 20b. Core elements 16b are fragments of a magnetic material formed by a sintered ferrite material. In the present example, sintered fragments 18b are formed by a ferrite material, which contains MnZn and NiZn compounds and has a relative permeability μ>500.

Core elements 16b are stacked in trough 20b, which is provided for accommodating core elements 16b, and are potted using binder 22b, which is formed by an epoxy resin. Binder 22b additionally contains a component of powdered core elements 24b. In one alternative embodiment, it is possible that binder 22b only coats core elements 16b with a thin lacquer film and glues them to one another. Intermediate spaces between core elements 16b are not completely filled with binder 22b in this case, so that air entrapments remain in core unit 14b.

To manufacture core unit 14b, core elements 16b are distributed in trough 20b in a first step. In a second step, binder 22b is added, which cures in a third step. Subsequently, core unit 14b may be installed in inductive charging coil device 10b. Alternatively, after the curing of binder 22b, trough 20b may be removed and used to manufacture further core units 14b.

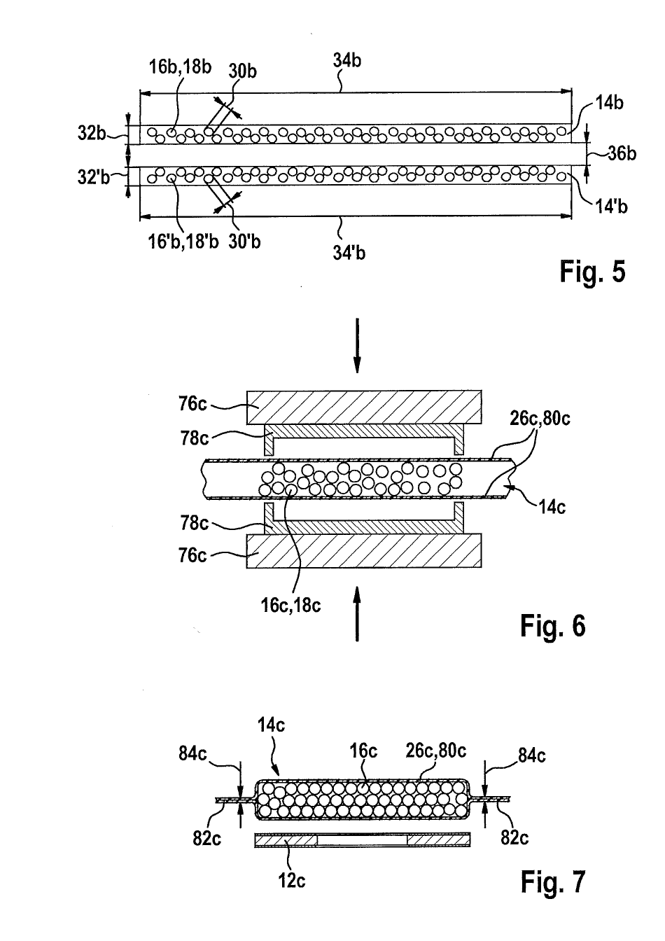

Core unit 14b has an essentially plate-shaped configuration. Core elements 16b have a mean diameter 30b, which is less than ⅔ of a core height 32b (FIG. 5). It may thus be ensured that core elements 16b are distributed uniformly in core unit 14b and core elements 16b may be prevented from protruding out of core unit 14b.

Inductive charging coil device 10b is part of a hand-held power tool device 38b (FIG. 4), which is implemented as a hand-held power tool rechargeable battery pack 40b. A cell unit 44b, which is provided to supply a hand-held power tool with energy, into which hand-held power tool rechargeable battery pack 40b may be inserted, is situated in a housing unit 42b. Hand-held power tool rechargeable battery pack 40b has a hand-held power tool rechargeable battery pack interface (not shown in greater detail here) for energy transfer to the hand-held power tool. Inductive charging coil device 10b is provided for wireless inductive energy transfer for a charging operation of cell unit 44b. Inductive charging coil device 10b is situated between cell unit 44b and a housing wall 46b of housing unit 42b. Proceeding from housing wall 46b in the direction of cell unit 44b, a coil unit 12b, core unit 14b, and an electronics unit 58b initially follow. Electronics unit 58b is connected with the aid of a connecting lead 48b to cell unit 44b and includes charging electronics for cell unit 44b. A contacting unit (not shown in greater detail here) connects coil unit 12b to electronics unit 58b.

Coil unit 12b is formed by a printed circuit board 52b. Coil unit 12b has a conductor loop 54b including a plurality of windings around a winding axis 56b on both sides of a carrier layer 50b of printed circuit board 52b. The windings of conductor loops 54b have the same winding direction. The windings are formed by the printed conductors of two conductor layers of printed circuit board 52b situated on carrier layer 50b. Feed-throughs (not shown in greater detail) through carrier layer 52b have a connecting lead, which electrically connects the ends of the windings closest to winding axis 56b, so that the two conductor loops 54b form an electric coil. The ends of the windings remote from winding axis 56b are connected to electronics unit 58b.

A shielding unit, which is formed by a conductor layer 60b, and which completely covers electronics unit 58b and cell unit 44b viewed in the direction of winding axis 56b, is situated on the side of electronics unit 58b facing toward core unit 14b. A magnetic alternating field in the area of coil unit 12b is in large part retroreflected in the direction of coil unit 12b by conductor layer 60b, so that a field strength in the area of cell unit 44b and the side of electronics unit 58b facing toward cell unit 44b, proceeding from conductor layer 60b, is reduced.

If inductive charging coil device 10b is subjected to the influence of an electromagnetic alternating field, a current is induced in conductor loops 54b of coil unit 12b, which may be used to charge cell unit 50b. To generate the electromagnetic alternating field, a second, similarly constructed inductive charging coil device 10′b is provided, which is situated in a hand-held power tool rechargeable battery charging device 72′b. Inductive charging coil device 10′b has an electronics unit 58′b, which, from a current supplied via a current supply 74′b, generates an alternating current having a frequency of 100 kHz and supplies a coil unit 12′b, so that the electromagnetic alternating field is generated. If hand-held power tool rechargeable battery pack 40b is placed with housing wall 46b on hand-held power tool rechargeable battery charging device 72′b, inductive charging coil device 10b thus enters the influence of the magnetic alternating field of inductive charging coil device 10′b, so that an energy transfer takes place. A core unit 14′b is provided to focus the electromagnetic alternating field generated by coil unit 12′b in the direction of coil unit 12b of hand-held power tool rechargeable battery pack 40b.

FIG. 5 shows the establishment of a minimal size of core elements 16b. If hand-held power tool rechargeable battery pack 40b is placed on hand-held power tool rechargeable battery charging device 72′b, it forms a system including the two inductive charging coil devices 10b and 10′b. The two core units 14b, 14′b shown in FIG. 5 each have a diameter 30b, 30′b and core height 32b, 32′b, which are identical in the example shown. An air gap 36b, which is defined by the mechanical structure of hand-held power tool rechargeable battery pack 40b and hand-held power tool rechargeable battery charging device 72′b, exists between the two core units 14b and 14′b. Air gap 36b is to be understood as a spacing between the two core units 14b and 14′b, in which further components are situated, in particular coil units 12b and 12′b and housing wall 46b and a housing wall 46′b of hand-held power tool rechargeable battery charging device 72′b.

Core elements 16b have mean diameter 30b, which is at least 10 μm multiplied by a ratio of a core diameter 34b of core unit 14b divided by air gap 36b in the operational state of inductive charging coil devices 10b, 10′b. A smallest mean diameter 30′b of core elements 16′b is similarly established as a function of a core diameter 34′b and air gap 36b.

FIGS. 6 and 7 show a manufacturing method of a core unit 14c (FIG. 7) for operation with a coil unit 12c in a third exemplary embodiment. Core unit 14c of the third exemplary embodiment differs from core unit 14b of the second exemplary embodiment in particular in that core unit 14c has a core jacket 26c, which is provided for fixing core elements 16c. Core elements 16c, which are formed by sintered fragments 18c, are situated between two layers of elastomeric material 80c. Two molds 78c, which are heated by heating plates 76c, are moved on both sides toward the layers of elastomeric material 80c, so that a vulcanization process begins and core unit 14c is formed. In core unit 14c, core elements 16c are wrapped in an envelope made of elastomeric material 80c. Protruding ends 82c of elastomeric material 80c may be cut off in a further step at cutting positions 84c. Core unit 14c thus formed has a high flexibility, since core elements 16c are situated loosely in core unit 14c.

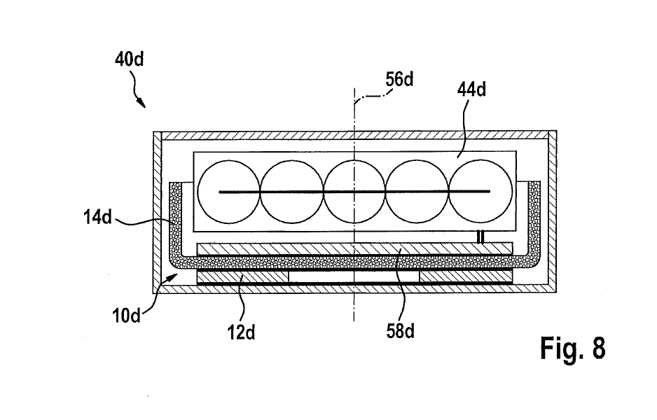

FIG. 8 shows a hand-held power tool rechargeable battery pack 40d including an inductive charging coil device 10d having a core unit 14d in a fourth exemplary embodiment. Core unit 14d of the third exemplary embodiment differs from core unit 14b of the second exemplary embodiment in particular in that core unit 14d has a trough-shaped configuration. In particular, core unit 14d completely encloses an electronics unit 58d around a winding axis 56d and partially encloses a cell unit 44d around winding axis 56d. Core unit 14d forms a shielding unit of electronics unit 58d and cell unit 44d. A magnetic field, which impacts core unit 14d from the direction of a coil unit 12d, is focussed by core unit 14d and concentrated in the area of coil unit 12d. A magnetic field strength is low on a side of core unit 14d facing away from coil unit 12d, so that influences of the magnetic alternating field on electronics unit 58d and cell unit 44d are reduced.

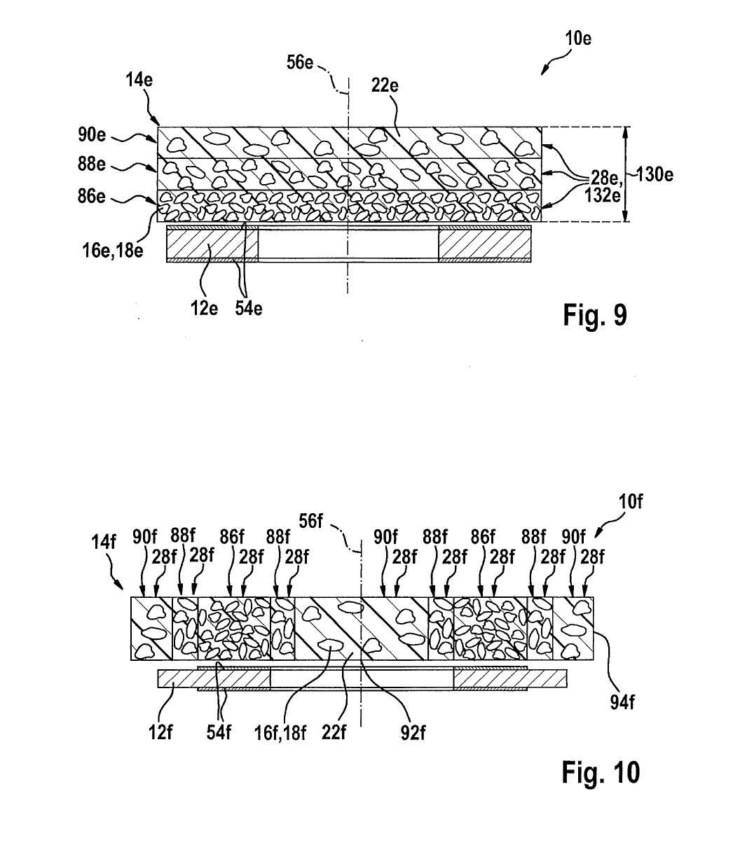

FIG. 9 shows a core unit 14e and a coil unit 12e of an inductive charging coil device 10e in a fifth exemplary embodiment. Core unit 14e of the fifth exemplary embodiment differs from the second exemplary embodiment in particular in that core unit 14e has areas 28e having a differing density of core elements 16e. Core elements 16e are formed by sintered fragments 18e. Areas 28e form layers 132e, which are situated adjacent to one another in a thickness direction 130e, which is oriented in a direction of a winding axis 56e of conductor loops 54e of coil unit 12e. An area of high density 86e of core elements 16e faces toward coil unit 12e. In this area of high density 86e, a field strength of a magnetic alternating field is greatest during operation of inductive charging coil device 10e. An area of low density 90e of core elements 16e is located on a side of core unit 14e facing away from coil unit 12e. A field strength of a magnetic alternating field is lowest in this area of low density 90e during operation of inductive charging coil device 10e. An area of moderate density 88e of core elements 16e lies between areas of high density 86e and low density 90e. Area of high density 86e has a mean relative permeability μ=200, area of moderate density 88e has a mean relative permeability μ=50, and area of low density 90e has a relative permeability μ=20. A proportion of a binder 22e, which connects core elements 16e, behaves in inverse proportion to the density of core elements 16e. The quantity of core elements 16e required for manufacturing core unit 14e is advantageously reduced.

FIG. 10 shows a core unit 14f and a coil unit 12f of an inductive charging coil device 10f in a sixth exemplary embodiment. Core unit 14f of the sixth exemplary embodiment differs from the first exemplary embodiment in particular in that core unit 14f has areas 28f having a differing density of core elements 16f. Core elements 16f are formed by sintered fragments 18f and are embedded in a binder 22f. Areas 28f are situated radially around a winding axis 56f. An area of high density 86f of core elements 16f is situated adjoining conductor loops 54f of coil unit 12f in the direction of winding axis 56f. A field strength of a magnetic alternating field is greatest in this area of high density 86f during operation of inductive charging coil device 10f. Areas of low density 90f of core elements 16f are located in an area 28f around a center 92f of core unit 14f and in an area adjoining an edge 94f of core unit 14f. These areas of low density 90f have a large distance to conductor loops 54f. A field strength of a magnetic alternating field is lowest in these areas of low density 90f during operation of inductive charging coil device 10f. Areas of moderate density 88f of core elements 16f are located between areas of high density 86f and low density 90f. In another embodiment of the present invention, it is possible that a distribution of areas 28f of differing density of core elements of the fifth and sixth exemplary embodiments are combined, i.e., a density of core elements 16f is a function of a distance to conductor loop 54f of coil unit 12f both axially and also radially.

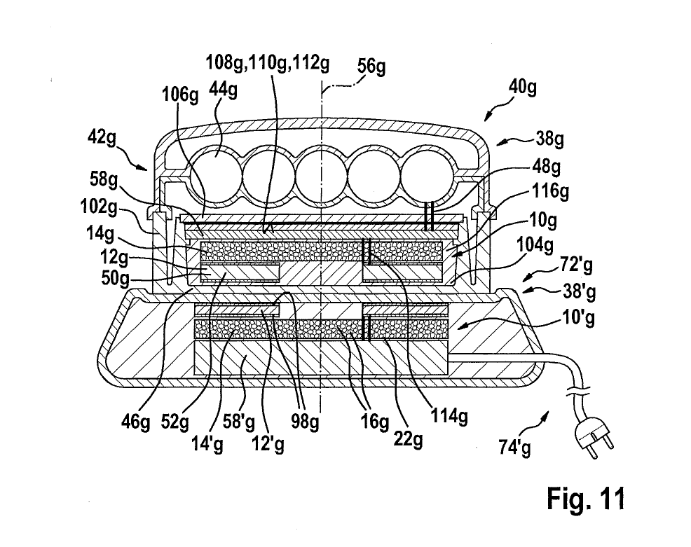

FIG. 11 shows a hand-held power tool device 38g including an inductive charging coil device 10g and a further hand-held power tool device 38g′ including an inductive charging coil device 10′g in a seventh exemplary embodiment. Hand-held power tool device 38g is implemented as a hand-held power tool rechargeable battery pack 40g, and hand-held power tool device 38g′ is implemented as a hand-held power tool rechargeable battery charging device 72′g. A cell unit 44g, which is provided to supply a hand-held power tool with energy, is situated in a housing unit 42g of hand-held power tool rechargeable battery pack 40g. Hand-held power tool rechargeable battery pack 40g has a hand-held power tool rechargeable battery pack interface (not shown in greater detail) for contacting with the hand-held power tool. Inductive charging coil device 10g is provided for wireless energy transfer for a charging operation of cell unit 44g. Inductive charging coil device 10g is situated between cell unit 44g and a housing wall 46g of a base part 102g of housing unit 42g. Proceeding from housing wall 46g in the direction of cell unit 44g, a coil unit 12g, a core unit 14g, and an electronics unit 58g initially follow. Electronics unit 58g includes charging electronics, which is provided to charge cell unit 44g.

Coil unit 12g is formed by a disk-shaped printed circuit board 52g. Printed circuit board 52g has, on both sides of a carrier layer 50g of printed circuit board 52g, a conductor loop in each case including windings 98g having a shared winding direction around a winding axis 56g. Windings 98g are formed by printed conductors of printed circuit board 52g. A connecting lead (not shown in greater detail here) connects windings 98g of the two conductor loops. Windings 98g therefore electrically form a coil of coil unit 12g. Core unit 14g, which is predominantly glued using a binder 22g and is formed by core elements 16g formed by a sintered ferrite material, is also disk-shaped and has the same diameter as coil unit 12g. A connecting lead 114g, which is led through core unit 14g, connects coil unit 12g to electronics unit 58g. Electronics unit 58g is connected with the aid of a connecting lead 48g to cell unit 44g.

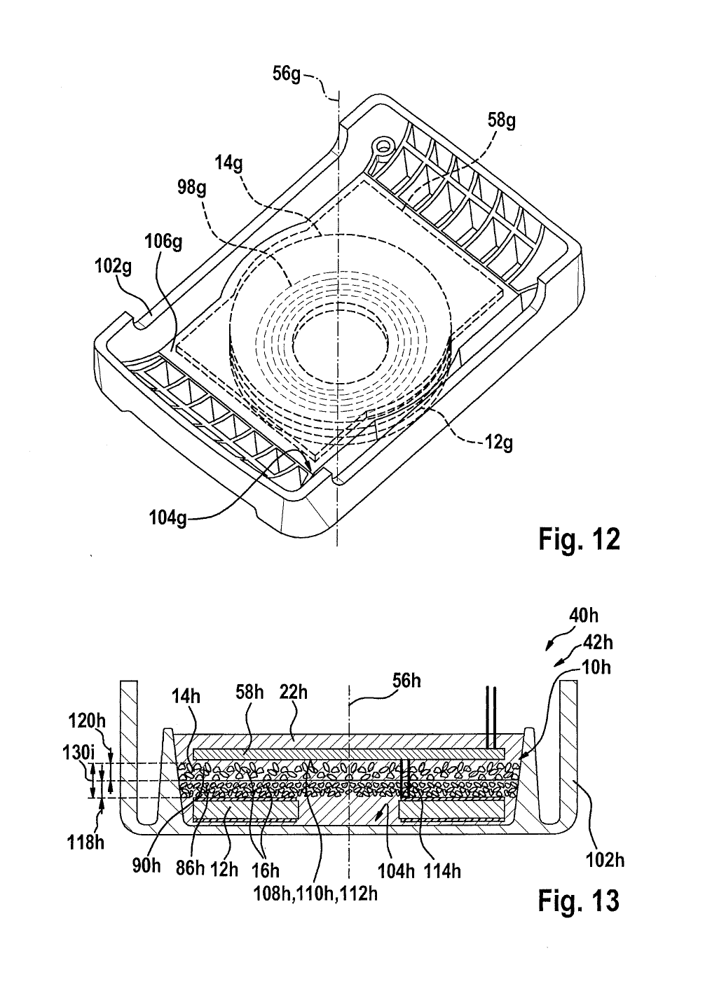

Base part 102g of housing unit 42g has a trough-shaped receptacle area 104g, which is provided to accommodate core unit 14g, coil unit 12g, and electronics unit 58g. Coil unit 12g, core unit 14g, and electronics unit 58g are inserted into a receptacle area 104g and subsequently potted using a potting compound 116g. Alternatively, it is possible that inductive charging coil device 10g is formed in a multicomponent injection molding method, during which coil unit 12g, core unit 14g, and electronics unit 58g are inserted into receptacle area 104g and subsequently extrusion coated using a thermoplastic. Connecting lead 48g remains led out of inductive charging coil device 10g, so that it may subsequently be connected to cell unit 44g. A cover element 106g (FIG. 12), which is formed by a plastic plate, covers inductive charging coil device 10g in receptacle area 104g in relation to cell unit 44g.

Cover element 106g has an electrically conductive material layer 110g, which is formed by a graphite lacquer. Material layer 110g forms a shielding unit 108g, which is situated between coil unit 12g and cell unit 44g. Material layer 110g has, in the case of a projection in the direction of winding axis 56g, a projection area 112g, which completely covers cell unit 44g. Shielding unit 108g shields cell unit 44g from influences of an electromagnetic alternating field occurring during operation of inductive charging coil device 10g.

If inductive charging coil device 10g is subjected to the influence of an electromagnetic alternating field, a current is induced in windings 98g of coil unit 12g, which may be used for charging cell unit 44g. Second, similarly constructed inductive charging coil device 10′g, which is situated in hand-held power tool rechargeable battery charging device 72′g, is provided for generating the electromagnetic alternating field. Inductive charging coil device 10′g has an electronics unit 58′g, which generates an alternating current having a frequency of 100 kHz from a current supplied via a current supply 74′g and supplies a coil unit 12′g, so that the electromagnetic alternating field is generated and focussed by a core unit 14′g. If hand-held power tool rechargeable battery pack 40g is placed on hand-held power tool rechargeable battery charging device 72′g, inductive charging coil device 10g thus enters the influence of the electromagnetic alternating field of inductive charging coil device 10′g, so that an energy transfer takes place.

FIG. 13 shows a base part 102h of a housing unit 42h of a hand-held power tool rechargeable battery pack 40h including an inductive charging coil device 10h in an eighth exemplary embodiment. Inductive coil charging device 10h of the eighth exemplary embodiment differs from inductive coil charging device 10g of the seventh exemplary embodiment in particular in that a coil unit 12h and an electronics unit 58h are embedded in a core unit 14h. Core unit 14h is formed by core elements 16h embedded in a binder 22h. Binder 22h is formed by an epoxy resin. Core elements 16h are formed by fragments of a sintered ferrite material. The core material composition made of binder 22h and core elements 16h differs in areas 86h, 90h of core unit 14h.

During manufacturing of inductive charging coil device 10h, initially coil unit 12h is introduced into a receptacle area 104h of base part 102h. In a next step, a layer 118h, which has core elements 16h in a high density, is applied to coil unit 12h. This layer 118h forms an area 86h of core unit 14h and has a relative permeability of μ=200. Layers 118h, 120h are situated adjacent to one another in a thickness direction 130h of core unit 14h, which is oriented in the direction of a winding axis 56h. Coil unit 12h and core elements 22h are potted using binder 22h. A further layer 120h is applied, which forms a further area 90h of core unit 14h and has core elements 22h in a low density, which are also potted using binder 22h. This layer 120h has a relative permeability of μ=50. Subsequently, electronics unit 58h is connected to coil unit 12h using a connecting lead 114h, which is led through layers 118h, 120h, and is also potted using binder 22h. Inductive charging coil device 10h forms a compact unit, which has a core unit 14h, which is formed by binder 22h and core elements 16h, and into which electronics unit 58h and coil unit 12h are embedded. On the side of electronics unit 58h facing toward coil unit 12h, a material layer 110h formed by a copper layer is situated, which forms a shielding unit 108h. Material layer 110h has a projection area 112h in the direction of winding axis 56h, which completely covers electronics unit 58h. Electronics unit 58h is protected by shielding unit 108h from influences of an electromagnetic alternating field from the area of coil unit 12h.

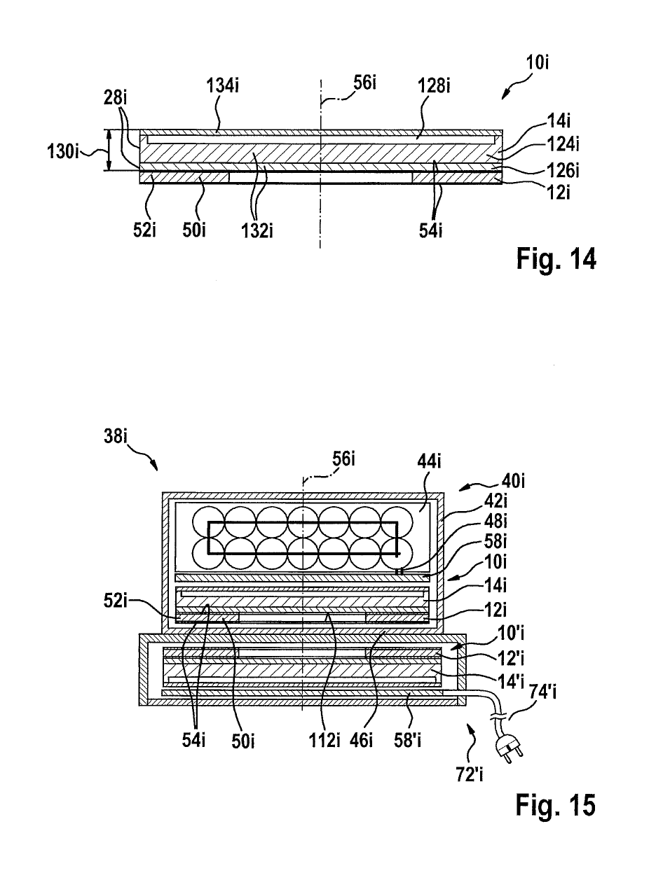

FIG. 14 shows a core unit 14i and a coil unit 12i of an inductive charging coil device 10i, which is shown in detail in FIG. 15, in a ninth exemplary embodiment. Core unit 14i has areas 28i having a differing core material composition. A first core material 124i has a mean relative permeability μ=50. A second core material 126i is applied to a side of core unit 14i facing toward coil unit 12i in a coating method to first core material 124i and has a mean relative permeability μ=200. Areas 28i, which are formed by core materials 124i, 126i, are integrally joined to one another. Areas 28i form layers 132i, which are situated adjacent to one another in a direction 130i, which is oriented in the direction of a winding axis 56i of coil unit 12i. On a side of core unit 14i facing away from coil unit 12i, it has a further area 28i, which is formed by air 128i. A cover layer 134i, which is formed by first core material 124i, covers area 28i formed by air 128i. Area 28i formed by air 128i has a mean relative permeability μ=20 jointly with cover layer 134i. Proceeding from the side facing toward coil unit 12i, relative permeability μ of the core unit decreases from μ=200 to μ=20.

Inductive charging coil device 10i is part of a hand-held power tool device 38i (FIG. 15), which is implemented as a hand-held power tool rechargeable battery pack 40i. A cell unit 44i, which is provided to supply a hand-held power tool with energy, into which hand-held power tool rechargeable battery pack 40i may be inserted, is situated in a housing unit 42i. Hand-held power tool rechargeable battery pack 40i has a hand-held power tool rechargeable battery pack interface (not shown in greater detail here) for energy transfer to the hand-held power tool. Inductive charging coil device 10i is provided for wireless inductive energy transfer for a charging operation of cell unit 44i. Inductive charging coil device 10i is situated between cell unit 44i and a housing wall 46i of housing unit 42i. Proceeding from housing wall 46i in the direction of cell unit 44i, coil unit 12i core unit 14i, and an electronics unit 58i initially follow. Electronics unit 58i is connected using a connecting lead 48i to cell unit 44i and includes charging electronics for cell unit 44i. A contacting unit (not shown in greater detail here) connects coil unit 12i to electronics unit 58i.

Coil unit 12i is formed by a printed circuit board 52i. Printed circuit board 52i has, on both sides of a carrier layer 50i, a conductor loop 54i in each case including a plurality of windings around winding axis 56i. The windings of conductor loops 54i have the same winding direction. The windings are formed by the printed conductors of two conductor layers of printed circuit board 52i which are situated on carrier layer 50i. Feed-throughs (not shown in greater detail) through carrier layer 50i have a connecting lead, which electrically connects the ends of the windings closest to winding axis 56i, so that the two conductor loops 54i electrically form a coil. The ends of the windings remote from winding axis 56i are connected to electronics unit 58i.

Core unit 14i has a projection area 112i, in the case of a projection in the direction of winding axis 56i, which completely covers electronics unit 58i and cell unit 44i. A magnetic alternating field in the area of coil unit 12i, which occurs during operation of inductive charging coil device 10i, is focussed by core unit 14i in the direction of coil unit 12i. A magnetic field strength remains low on a side of core unit 14i facing toward electronics unit 58i and cell unit 44i, so that the field strength in the area of cell unit 44i and electronics unit 58i is strongly reduced in relation to the field strength in the area of coil unit 12i. Core unit 14i therefore forms a shielding unit for electronics unit 58i and cell unit 44i. A further shielding unit may be omitted.

If inductive charging coil device 10i is subjected to the influence of a magnetic alternating field, a current is induced in conductor loops 54i of coil unit 12i, which may be used to charge cell unit 44i. A second, similarly constructed inductive charging coil device 10′i, which is situated in hand-held power tool device 38i implemented as hand-held power tool rechargeable battery charging device 72′i, is provided to generate the magnetic alternating field. Inductive charging coil device 10′i has an electronics unit 58′i, which generates an alternating current having a frequency of 100 kHz from a current supplied via a current supply 74′i and supplies a coil unit 12′i, so that the magnetic alternating field is generated. If hand-held power tool rechargeable battery pack 40i is placed with housing wall 46i on hand-held power tool rechargeable battery charging device 72′i, inductive charging coil device 10i thus enters the influence of the magnetic alternating field of inductive charging coil device 10′i, so that an energy transfer takes place. A core unit 14′i is provided to focus the magnetic alternating field generated by coil unit 12′i in the direction of coil unit 12i of hand-held power tool rechargeable battery pack 40i.

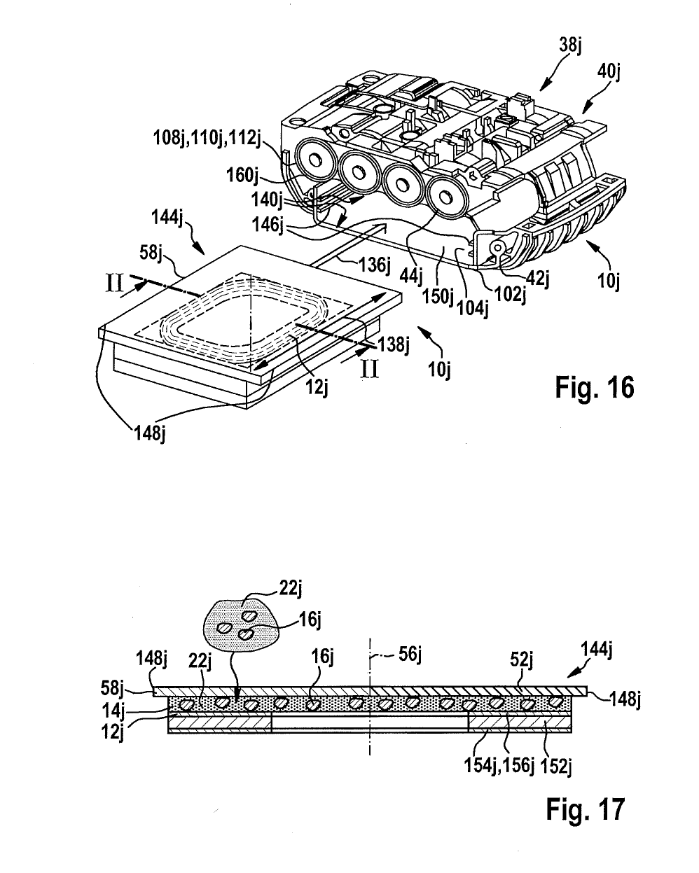

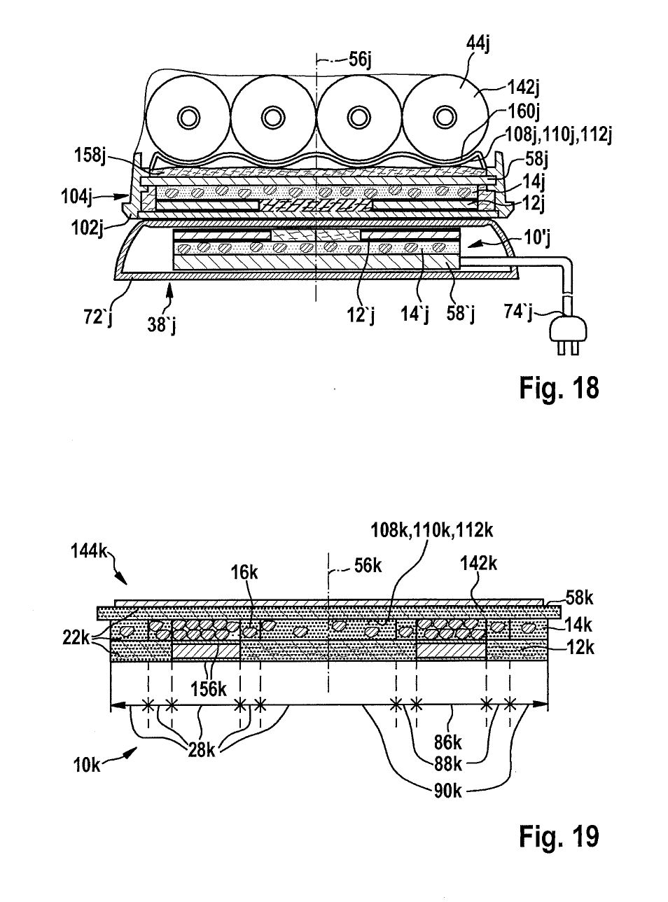

FIG. 16 shows a hand-held power tool device 38j, which is implemented as a hand-held power tool rechargeable battery pack 40j, including an inductive charging coil device 10j. Inductive charging coil device 10j has a coil unit 12j, a core unit 14j, and an electronics unit 58j, which are implemented as a coil module 144j. FIG. 17 shows a sectional view along a section plane II of coil module 144j shown in FIG. 16. A part of hand-held power tool rechargeable battery pack 40j forms a housing unit 42j of inductive charging coil device 10j having a pocket-like receptacle area 104j, which is situated in a base part 102j, for coil module 144j having coil unit 12j, core unit 14j, and electronics unit 58j. Coil unit 12j of coil module 144j is formed by a printed circuit board 152j, which has conductor layers 154j on both sides, which form printed conductors. The printed conductors form conductor loops 156j of coil unit 12j, which have windings on both sides, and have a shared winding direction around a winding axis 56j. The two conductor loops 156j are connected to a connecting lead (not shown in greater detail), so that the two conductor loops 156j electrically form a coil. Core unit 14j is formed by core elements 16j, which are connected using a binder 22j, and covers coil unit 12j. Core elements 16j are predominantly made of a ferrite material. Electronics unit 58j is situated adjoining core unit 14j, edges 148j of electronics unit 58j protruding beyond coil unit 12j and core unit 14j. Coil unit 12j and electronics unit 58j are connected using a connecting lead (not shown in greater detail), which is led through core unit 14j. Receptacle area 104j is provided to accommodate coil module 144j in an insertion direction 136j, which is aligned in parallel to a main surface extension 138j of coil unit 12j, core unit 14j, and electronics unit 58j. Two guide rails 146j, which are situated in parallel to insertion direction 136j, are situated in receptacle area 104j in such a way that two edges 148j of electronics unit 58j may be inserted into guide rails 146j in insertion direction 136j. Edges 148j are formed by a printed circuit board 52j of electronics unit 58j, which includes charging electronics. Edges 148j are situated on opposite sides of receptacle area 104j in relation to a direction parallel to main surface extension 138j and perpendicular to insertion direction 136j. Main surfaces 140j of receptacle area 104j are implemented as closed. An assembly opening 150j, through which coil module 144j is inserted in insertion direction 136j, is closed by a cover (not shown in greater detail) after assembly of inductive charging coil device 10j. A cell unit 44j of hand-held power tool rechargeable battery pack 40j is situated on a side of hand-held power tool rechargeable battery pack 40j opposite base part 102j, which has coil module 144j. Hand-held power tool rechargeable battery pack 40j is connected after installation of coil module 144j with the aid of a connecting lead (not shown in greater detail) to charging electronics of electronics unit 58j. Coil module 144j is potted using an epoxy resin 158j in receptacle area 104j after assembly for fixing and for protection from environmental influences (FIG. 18).

Cell unit 44j forms an assembly 142j, which is to be shielded to prevent loss currents induced by an electromagnetic field in cell unit 44j required for operating inductive charging coil device 10j. For shielding, a shielding unit 108j is provided, which is formed by a material layer 110j, which has a projection area 112j in the case of a projection in the direction of winding axis 56j of coil unit 12j, which essentially covers cell unit 44j. Material layer 110j is formed by an electrically conductive lacquer layer, which is applied to a partition wall 160j, which separates receptacle area 104j from cell unit 44j.

To charge cell unit 44j, hand-held power tool rechargeable battery pack 40j is placed on a hand-held power tool device 38′j (FIG. 18), which is implemented as a hand-held power tool rechargeable battery charging device 72′j, and which includes a similarly constructed inductive charging coil device 10′j. Hand-held power tool rechargeable battery charging device 72′j has a current supply 74′j. If hand-held power tool rechargeable battery charging device 72′j is supplied with current, a high-frequency alternating current of 100 kHz, which is generated by charging electronics situated on electronics unit 58′j, flows through inductive charging coil device 10′j. A magnetic alternating field is generated in coil unit 12′j, which is focussed by core unit 14′j and emitted essentially in the direction of inductive charging coil device 10j. A current, using which cell unit 44j may be charged, is induced in coil unit 12j of inductive charging coil device 10j.

FIG. 19 shows a coil module 144k of an inductive charging coil device 10k in a second exemplary embodiment. Coil module 144k differs from coil module 144j of the first exemplary embodiment in particular in that a coil unit 12k and an electronics unit 58k are partially embedded in a core unit 14k. Core unit 14k is formed by core elements 16k, which are implemented as fragments of a ferrite material, embedded in a binder 22k. A core material composition, which is formed by a ratio of binder 22k and core elements 16k, differs in areas 28k of core unit 14k. Core unit 14k has a first, ring-shaped area 28k, which is formed by an area of higher density 86k having a relative permeability μ=200, in the direction of a winding axis 56k, adjoining conductor loops 156k of coil unit 12k formed by a printed circuit board. Ring-shaped areas of moderate density 88k of core material having a relative permeability μ=50, adjoin this area of high density 86k on the inside and outside in relation to winding axis 56k. On the outside and inside, core unit 14k is delimited by areas 28k, which are formed by areas of low density 90k. Electronics unit 58k and coil unit 12k are situated on both sides of areas 28k in relation to winding axis 56k and also potted using binder 22k of core unit 14k during the manufacturing of core unit 14k. Coil unit 12k and electronics unit 58k are partially embedded in core unit 14k and form coil module 144k. A conductive material layer 110k having a projection area 112k, which covers electronics unit 58k in the case of a projection in the direction of winding axis 56k, is situated on a side of electronics unit 58k facing toward coil unit 12k. Material layer 110k forms a shielding unit 108k, which shields an electromagnetic alternating field originating from coil unit 12k in relation to electronics unit 58k, which forms an assembly 142k to be shielded.

Coil module 144k is provided, as in the first exemplary embodiment, to be inserted into a pocket-like receptacle area of a housing unit in an insertion direction to form an inductive charging coil device 10k.

1-13. (canceled)

14. An inductive charging coil device, comprising:
at least one coil unit; and
at least one core unit;
wherein the core unit is at least partially formed by microscopic core elements embedded in a binder.

15. An inductive charging coil device, comprising:
at least one coil unit; and
at least one core unit;
wherein the core unit has a plurality of core elements, which are at least partially formed by sintered fragments.

16. The inductive charging coil device of claim 14, wherein the core unit has a core jacket, which is provided for fixing the core elements.

17. An inductive charging coil device, comprising:
at least one coil unit; and
at least one core unit;
wherein the core unit has areas having a differing core material composition.

18. The inductive charging coil device of claim 14, wherein the core unit has at least two core materials, which have differing permeabilities.

19. The inductive charging coil device of claim 14, wherein the core unit has at least two core materials, which have at least one of differing densities and moduli of elasticity.

20. The inductive charging coil device of claim 17, wherein at least two areas, having a differing core material composition in a thickness direction of the core unit, form layers situated adjacent to one another.

21. The inductive charging coil device of claim 17, wherein at least two areas having a differing core material composition are situated radially around a winding axis of the coil unit.

22. The inductive charging coil device of claim 14, further comprising:
a housing unit, into which the core unit is at least one of cast and injection molded.

23. The inductive charging coil device of claim 14, further comprising:
a housing unit having a pocket-like receptacle area for at least one of the coil unit, the core unit, and an electronics unit.

24. A system, comprising:
at least two inductive charging coil devices, wherein each of the inductive charging coil devices includes at least one coil unit and at least one core unit;
wherein the core unit of at least one of the inductive charging coil devices has a plurality of core elements, which are at least partially formed by sintered fragments, and wherein the core elements have a mean diameter, which is at least 10 μm multiplied by a ratio of a core diameter of the core unit divided by an air gap in at least one operating state of the inductive charging coil devices.

25. A method for manufacturing a core unit of an inductive charging coil device, the device including at least one coil unit and the core unit, the method comprising:
at least partially forming the core unit by microscopic core elements embedded in a binder.

26. The inductive charging coil device of claim 14, wherein the inductive charging coil device includes a hand-held power tool inductive charging coil device.

27. The inductive charging coil device of claim 15, wherein the inductive charging coil device includes a hand-held power tool inductive charging coil device.

28. The inductive charging coil device of claim 17, wherein the inductive charging coil device includes a hand-held power tool inductive charging coil device.

29. A hand-held power tool device, comprising:
an inductive charging coil device, including at least one coil unit and at least one core unit, wherein the core unit is at least partially formed by microscopic core elements embedded in a binder.

30. A hand-held power tool device, comprising:
an inductive charging coil device, including at least one coil unit and at least one core unit, wherein the core unit has a plurality of core elements, which are at least partially formed by sintered fragments.

31. A hand-held power tool device, comprising:
an inductive charging coil device, including at least one coil unit and at least one core unit, wherein the core unit has areas having a differing core material composition.
